(19) United States
(12) Patent Application Publication
(10) Pub. No.: US 2023/0101037 A1
(43) Pub. Date: Mar. 30, 2023

(54) DETERMINING OPTIMIZED PARKING BASED ON USER PREFERENCES

(71) Applicant: International Business Machines Corporation, Armonk, NY (US)

(72) Inventors: Stephen Haertel, Ajax (CA); Lior Aronovich, Thornhill (CA)

(21) Appl. No.: 17/487,097

(22) Filed: Sep. 28, 2021

(51) Int. Cl. G08G 1/14; G06F 16/2457; H04L 29/08

(52) U.S. Cl. CPC G08G 1/144; G06F 16/24578; H04L 67/306

(57) ABSTRACT

A computer-implemented method for vehicle parking analysis and identification is disclosed. The computer-implemented method includes determining one or more parking preferences and one or more parking requirements of a user. The computer-implemented method includes determining one or more parking spaces based on comparing the one or more ranked parking preferences and the one or more ranked parking requirements of the user to parking data associated with one or more available parking spaces. The computer-implemented method includes generating a parking space recommendation, wherein the parking space recommendation includes the one or more optimal parking spaces selected from the one or more available parking spaces.

### BACKGROUND

The present invention relates generally to the field of vehicle parking, and more particularly, determining vehicle parking options based on user preferences.

Different parking spaces for vehicles, motorcycles, bicycles, or other modes of transportation have different properties, including particular locations, sizes, prices, and other parameters. For example, some parking spaces are covered, and some are a particular size and can only accommodate certain size vehicles. As another example, some parking spaces have different prices depending on the time of day or day of the week the vehicle is parked in the spot. Accordingly, not all parking spaces are able to accommodate particular vehicle requirements or an individual's personal preferences.

### SUMMARY

According to one embodiment of the present invention, a computer-implemented method for vehicle parking analysis and identification is disclosed. The computer-implemented method includes determining one or more parking preferences and one or more parking requirements of a user. The computer-implemented method includes determining one or more parking spaces based on comparing one or more ranked parking preferences and one or more ranked parking requirements of the user to parking data associated with one or more available parking spaces. The computer-implemented method includes generating a parking space recommendation, wherein the parking space recommendation includes one or more optimal parking spaces selected from the one or more available parking spaces.

According to another embodiment of the present invention, a computer program product for vehicle parking analysis and identification is disclosed. The computer program product includes one or more computer readable storage media and program instructions stored on the one or more computer readable storage media. The program instructions include instructions to determine one or more parking preferences and one or more parking requirements of a user. The program instructions include further instructions to determine one or more parking spaces based on comparing one or more ranked parking preferences and one or more ranked parking requirements of the user to parking data associated with one or more available parking spaces. The program instructions include further instructions to generate a parking space recommendation, wherein the parking space recommendation includes one or more optimal parking spaces selected from the one or more available parking spaces.

According to another embodiment of the present invention, a computer system for vehicle parking analysis and identification is disclosed. The computer system includes one or more computer processors, one or more computer readable storage media, and program instructions stored on the computer readable storage media for execution by at least one of the one or more computer processors. The program instructions include instructions to determine one or more parking preferences and one or more parking requirements of a user. The computer program product includes one or more computer readable storage media and program instructions stored on the one or more computer readable storage media. The program instructions include further instructions to determine one or more parking spaces based on comparing one or more ranked parking preferences and one or more ranked parking requirements of the user to parking data associated with one or more available parking spaces. The program instructions include further instructions to generate a parking space recommendation, wherein the parking space recommendation includes the one or more optimal parking spaces selected from the one or more available parking spaces.

### BRIEF DESCRIPTION OF DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of a network computing environment for determining parking spaces based on user preferences, generally designated 100, in accordance with at least one embodiment of the present invention.

FIG. 2 is a flow chart diagram depicting operational steps for determining parking spaces based on user preferences, generally designated 200, in accordance with at least one embodiment of the present invention.

FIG. 3 is a block diagram depicting components of a computer, generally designated 300, suitable for executing a parking preference program 101 in accordance with at least one embodiment of the present invention.

FIG. 4 is a block diagram depicting a cloud computing environment 50 in accordance with at least one embodiment of the present invention.

FIG. 5 is block diagram depicting a set of functional abstraction model layers provided by cloud computing environment 50 depicted in FIG. 4 in accordance with at least one embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The present invention relates generally to the field of vehicle parking, and more particularly, determining vehicle parking options based on user preferences.

When searching for a parking space, there are usually many different options. Different parking locations, spaces, garages, or lots have different prices, amenities, size of the space, and availability. Individuals have different preferences such as how much they're willing to pay or how far they're willing to walk from the parking space to their destination. Some individuals require large parking spaces for an SUV while other individuals only need a small parking space for a bicycle, motorcycle, or scooter. Oftentimes, users research the best parking space based on their requirements and preferences before traveling. It is extremely time consuming for an individual to parse through the various different parking options in order to determine a space that meets their vehicle parking requirements and individual preferences.

Embodiments of the present invention recognize the need for a user to be able to easily determine a parking space that meets their vehicle parking requirements and individual preferences. Embodiments of the present invention recognize that different vehicle and users will have different vehicle parking requirements and personal preferences. For example, a requirement such as parking size, is a hard requirement, while having an elevator may be a personal preference for convenience sake. However, for another individual, an elevator, or handicap accessibility, may be a requirement. Accordingly, embodiments of the present invention determine one or more optimal parking spaces based on vehicle parking requirements and individual user preferences.

The present invention may be a system, a method, and/or a computer program product at any possible technical detail level of integration. The computer program product may include a computer readable storage medium (or media) having computer readable program instructions thereon for causing a processor to carry out aspects of the present.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

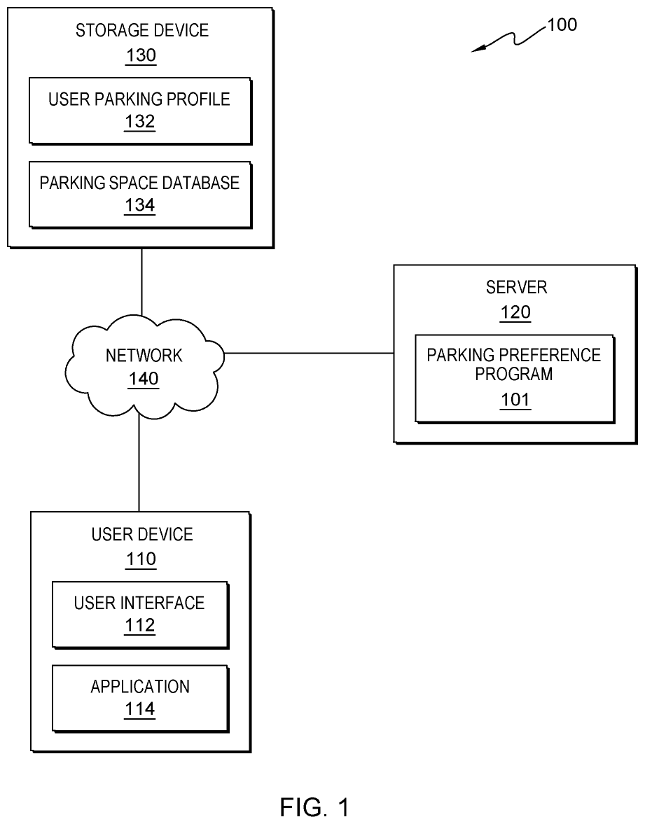

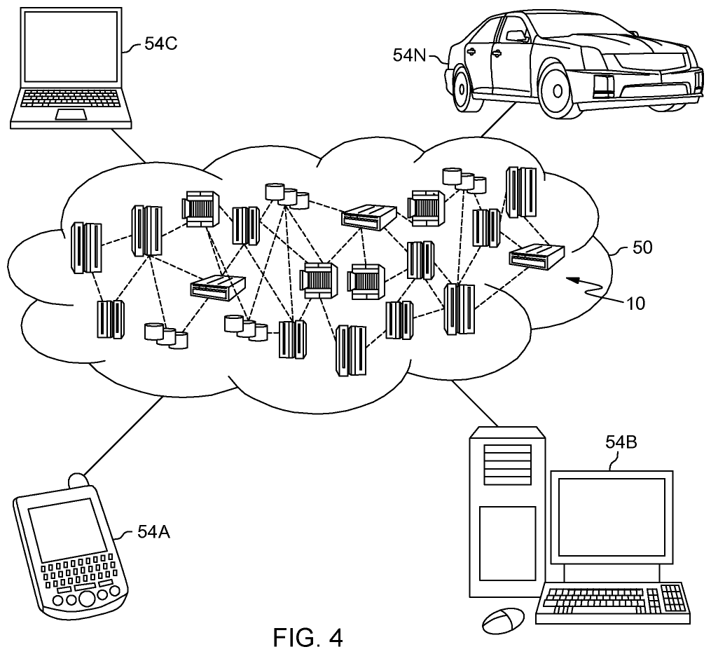

The present invention will now be described in detail with reference to the Figures. FIG. 1 is a functional block diagram of a network computing environment determining parking spaces based on user preferences, generally designated 100, in accordance with at least one embodiment of the present invention. In an embodiment, network computing environment 100 may be provided by cloud computing environment 50, as depicted and described with reference to FIG. 4, in accordance with at least one embodiment of the present invention. FIG. 1 provides an illustration of only one implementation and does not imply any limitations with regard to the environments in which different embodiments may be implemented. Many modifications to the depicted environment may be made by those skilled in the art without departing from the scope of the present invention as recited by the claims.

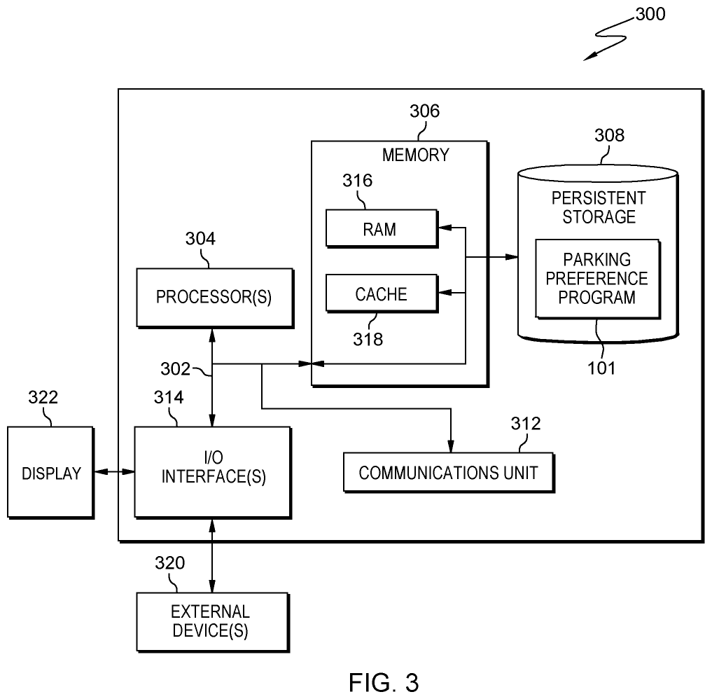

Network computing environment 100 includes user device 110, server 120, and storage device 130 interconnected over network 140. User device 110 may represent a computing device of a user, such as a laptop computer, a tablet computer, a netbook computer, a personal computer, a desktop computer, a personal digital assistant (PDA), a smart phone, a wearable device (e.g., smart glasses, smart watches, e-textiles, AR headsets, etc.), or any programmable computer systems known in the art. In general, user device 110 can represent any programmable electronic device or combination of programmable electronic devices capable of executing machine readable program instructions and communicating with server 120, storage device 130 and other devices (not depicted) via a network, such as network 140. User device 110 can include internal and external hardware components, as depicted and described in further detail with respect to FIG. 3.

User device 110 further includes user interface 112 and application 114. User interface 112 is a program that provides an interface between a user of an end user device, such as user device 110, and a plurality of applications that reside on the device (e.g., application 114). A user interface, such as user interface 112, refers to the information (such as graphic, text, and sound) that a program presents to a user, and the control sequences the user employs to control the program. A variety of types of user interfaces exist. In one embodiment, user interface 112 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 112 is a script or application programming interface (API).

Application 114 can be representative of one or more applications (e.g., an application suite) that operate on user device 110. In an embodiment, application 114 is representative of one or more applications (e.g., social media applications, web conferencing applications, email applications, or parking applications) located on user device 110. In various example embodiments, application 114 can be an application that a user of user device 110 utilizes to input user parking preferences, parking requirements, and parking location. In an embodiment, application 114 can be an application that a user of user device 110 utilizes to view one or more parking recommendations based on the user input. In an embodiment, application 114 can be an application that a user of user device 110 utilizes to view directions to the selected or recommended parking space. In an embodiment, application 114 can be a client-side application associated with a server-side application running on server 120 (e.g., a client-side application associated with parking preference program 101). In an embodiment, application 114 can operate to perform processing steps of parking preference program 101 (i.e., application 114 can be representative of parking preference program 101 operating on user device 110).

Server 120 is configured to provide resources to various computing devices, such as user device 110. In various embodiments, server 120 is a computing device that can be a standalone device, a management server, a web server, an application server, a mobile device, or any other electronic device or computing system capable of receiving, sending, and processing data. In an embodiment, server 120 represents a server computing system utilizing multiple computers as a server system, such as in a cloud computing environment. In an embodiment, server 120 represents a computing system utilizing clustered computers and components (e.g. database server computer, application server computer, web server computer, webmail server computer, media server computer, etc.) that act as a single pool of seamless resources when accessed within network computing environment 100. In general, server 120 represents any programmable electronic device or combination of programmable electronic devices capable of executing machine readable program instructions and communicating with each other, as well as with user device 110, storage device 130, and other computing devices (not shown) within network computing environment 100 via a network, such as network 140.

In an embodiment, server 120 includes parking preference program 101. In an embodiment, parking preference program 101 may be configured to access various data sources, such as the user parking profile 132 and parking space database 134 that may include personal data, content, contextual data, or information that a user does not want to be processed. Personal data includes personally identifying information or sensitive personal information as well as user information, such as location tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In an embodiment, parking preference program 101 enables the authorized and secure processing of personal data. In an embodiment, parking preference program 101 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. In an embodiment, parking preference program 101 provides information regarding personal data and the nature (e.g., type, scope, purpose, duration, etc.) of the processing. In an embodiment, parking preference program 101 provides a user with copies of stored personal data. In an embodiment, parking preference program 101 allows for the correction or completion of incorrect or incomplete personal data. In an embodiment, parking preference program 101 allows for the immediate deletion of personal data.

Server 120 may include components as depicted and described in detail with respect to cloud computing node 10, as described in reference to FIG. 4, in accordance with at least one embodiment of the present invention. Server 120 may include components, as depicted and described in detail with respect to computing device 300 of FIG. 3, in accordance with at least one embodiment of the present invention.

In various embodiments, storage device 130 is a secure data repository for persistently storing parking requirements and individual parking preferences and user devices of a user, such as user device 110. Storage device 130 may be implemented using any volatile or non-volatile storage media known in the art for storing data. For example, storage device 130 may be implemented with a tape library, optical library, one or more independent hard disk drives, multiple hard disk drives in a redundant array of independent disks (RAID), solid-state drives (SSD), random-access memory (RAM), and any possible combination thereof. Similarly, storage device 130 may be implemented with any suitable storage architecture known in the art, such as a relational database, an object-oriented database, or one or more tables.

In an embodiment, parking preference program 101 includes user parking profile 132 and parking space database 134. In an embodiment, user parking profile 132 includes information received from user input. In an embodiment, parking preference program 101 receives user input indicating various parking requirements and individual parking preferences. In an embodiment, parking preference program 101 stores information received from a user as user parking profile 132. In an embodiment, parking preference program 101 stores information received from a user such as the users ranking of the user parking references and parking requirements. In an embodiment, parking preference program 101 learns a vehicles parking requirements or a user's preferences over time. For example, if a user indicates the vehicle they drive is Manufacturer A, Model B, then parking preference program 101 may look up dimensions for Manufacturer A, Model B and determine the vehicle is 12′×6′×5.5′. In an embodiment, parking preference program 101 uses the determined dimensions to determine where the vehicle can fit in to park. In another example, parking preference program 101 determines over time that a particular user always parks indoors or in a covered area when it is raining outside.

In an embodiment, user parking profile 132 includes information vehicle parking requirements and individual parking preferences. For example, a parking preference is a preferable feature while a parking requirement is necessary for a parking location or space. In an embodiment, a parking location includes the general vicinity where a vehicle can be parked, and parking space includes the actual space where the vehicle is to be parked. In an example, user parking profile 132 stores information on a parking preference for a parking space under $5/hour. In an embodiment, user parking profile 132 includes information on a maximum distance that a user is willing to park their vehicle from their final destination. In an embodiment, user parking profile 132 includes information on an amount of allotted time of the user to travel from a parking space to a final destination. In another example, user parking profile 132 stores information on a parking requirement for a parking space within a quarter mile of the destination. In an embodiment, the destination is the location of where the user is going. In an embodiment, there is one or more destinations. For example, a first destination can be stadium A and a second destination can be restaurant B. In this example, user indicates a preference of a parking space within a quarter mile of the first and the second destination. In an embodiment, user parking profile 132 includes information on the type or size of one or more vehicles. In an embodiment, user parking profile 132 includes information on parking requirements and preferences the user previously used.

In an embodiment, parking space database 134 includes information associated with various parking spaces or locations. In an embodiment, parking space database 134 includes information associated with particular parking locations, spaces, garages, lots, and their respective qualities. For example, parking space database 134 includes information on the price of parking at various times, particular parking space locations, particular parking space features, including, but not limited to, size, open-air vs. covered parking, direct access to other areas, past parking space availability, real-time parking space availability, and predicted parking space availability at a future point in time, and amenities of a parking garage. An amenity can include, for example, elevator access, security, handicap accessibility, roof coverage, off-site travel methods such as a shuttle, or valet service. In an embodiment, parking space database 134 includes historical parking information associated with parking spaces that user previously used to park their vehicle.

In an embodiment, parking preference program 101 receives user input for parking preferences. In an embodiment, user input includes preferences or requirements for a parking space. In an embodiment, user input includes parameters, preferences, or requirements such as limit of travel time from the parking location to the destination, location of destination, location of parking, method of travel from parking location to final destination, cost per unit of time, absolute cost, vehicle type, parking location features, security, shuttle services, or parking location. In an embodiment, user input is saved and accessed via user parking profile 132 for multiple uses. For example, parking preference program 101 receives user input of “SUV” and “handicap accessibility” as parking requirements and stores this information in user parking profile 132. In this example, parking preference program 101 accesses user parking profile 132 to access the users parking requirements.

In an embodiment, parking preference program 101 ranks the user parking input preferences. In an embodiment, parking preference program 101 assigns a value or weight to every parking requirement or parking preference. For example, parking preference program 101 assigns a higher value or score to a parking requirement than a parking preference. In an example, parking preference program 101 assigns a weight of 1.0 to parking requirement “handicap accessibility” and weight of 0.3 to parking preference “covered roof.”

In an embodiment, parking preference program 101 receives preferred rankings from the user. For example, a user can indicate a higher preference to park in the shade or covered area than a parking space near an elevator. In this example, parking preference program 101 assigns a higher weight to parking preference “covered space” than “elevator.” Such as, assigning a weight of 0.6 to parking preference “covered spot” and 0.4 to “elevator.”

In an embodiment, parking preference program 101 receives and parses ranked user preferences based, at least in part on, at least one of: (i) limits of travel time of parking location to destination, (ii) preference of travel method from parking location to destination (i.e., walking, shuttle bus), (iii) limits of cost per unit of time, and absolute cost, (iv) vehicle type, (v) preferred parking location features, and (vi) ranking of the preferences indicating whether the preferences are strict or not, where an indication that a preference is strict will cause options which do not satisfy it to be filtered out.

In an embodiment, parking preference program 101 determines one or more parking spaces which satisfy the vehicle parking requirements and individual user parking preferences. In an embodiment, parking preference program 101 determines one or more parking spaces which satisfy the parking requirements and/or preferences. In an embodiment, parking preference program 101 compares the information included in user parking profile 132 with one or more parking options. In an embodiment, parking preference program 101 matches parking options with the user input requirements and preferences. For example, parking preference program 101 receives input for parking preference of $5/hour or lower. In this example, parking preference program 101 determines a parking location is a match if the hourly rate for a parking space is $5 or less. In an embodiment, parking preference program 101 automatically filters out parking locations which do not satisfy one or more user input parking requirements. For example, if a parking requirement is wheelchair accessible, parking preference program 101 filters out any parking locations that are not wheelchair accessible. For example, wheelchair accessible may be a parking space on the ground floor, a parking space near an elevator, or a parking location that has handicap parking spaces.

In an embodiment, parking preference program 101 ranks and parses one or more determined optimal parking spaces based, at least in part on, at least one of: (i) limits of travel time of parking location to destination, (ii) preference of travel method from parking location to destination (i.e., walking, shuttle bus), (iii) limits of cost per unit of time, and absolute cost, (iv) vehicle type, (v) preferred parking location features, and (vi) ranking of the preferences indicating whether the preferences are strict or not, where an indication that a preference is strict will cause options which do not satisfy it to be filtered out. In an embodiment, an optimal parking space is a parking space that has a ranking above a predetermined threshold.

In an embodiment, parking preference program 101 ranks the one or more parking spaces which satisfy the parking input. In an embodiment, parking preference program 101 ranks the one or more parking spaces based on the user input. For example, user input indicates a parking requirement of (i) time to final destination 5 minutes or under and (ii) vehicle accommodation car and parking preferences of (iii) cost $5 hour or less and (iv) covered parking. Based on the user indicated parking requirements and preferences, parking preference program 101 determines the following parking space options:

Parking option A includes: (i) 6 minutes to final destination; (ii) vehicle accommodation car; (iii) cost $4 per hour; and (iv) covered parking.

Parking option B includes: (i) 4 minutes to final destination; (ii) vehicle accommodation car; (iii) cost $4 per hour; and (iv) no covered parking.

Parking option C includes: (i) 2 minutes to final destination; (ii) vehicle accommodation car; (iii) cost $5 per hour; and (iv) covered parking.

Parking option D includes: (i) 6 minutes to final destination; (ii) vehicle accommodation bicycle; (iii) cost $1 per hour; and (iv) covered parking.

In this example, parking preference program 101 may filter out any parking options which are farther than 5 minutes to the final destination and cannot accommodate a car. Although parking option B does not have the preferred feature of covered parking, parking option B is not filtered out because covered parking is only a preferred feature and not a requirement. Here, parking options A and D are removed for being unable to accommodate a car and being farther than 5 minutes from the final destination. Parking options B and C are ranked and displayed to user. For example, if a user indicated parking preference “covered parking” is more important than “cost $5 hour or less,” parking preference program 101 assigns a higher weight to “covered parking.” Therefore, parking preference program 101 indicated parking option C as the best parking space.

In an embodiment, parking preference program 101 calculates a final match score by the following algorithm:

MatchScore[OfParkingOption]=function(PrefParam₁Score, PrefParam₂Score, PrefParam₃Score, . . . , parameterRankings, additionalConsiderations, historicalChoices, parkingSupplyEstimate)

In an embodiment, the PrefParam_{X}Score values are individually calculated for each specified parameter of user preferences. In an embodiment, parameterRankings is the ranking determined from user input of preferences and requirements. In an embodiment, parameterRankings are rankings on the user's preferences parameters and the ranking specify the relative importance of each preference parameter. In an embodiment, additionalConsideration are overridden user preferences for a particular search for parking, and in addition variable factors such as current user location, route, route traffic, and route meteorological data. In an embodiment, historicalChoices are based on the user's historically selected parking spaces. In an embodiment, parkingSupplyEstimate is the estimate of available parking spaces at the parking space location.

In an embodiment, each specified parameter is calculated as functions of the difference between the user's preferred values and the parking location's actual values. In an embodiment, the score contributed by the parameter for the required parking location feature of being covered is a function of the user's desired value and the parking location's actual feature of being covered. In an embodiment, the score contributed by the parameter for the required parking location feature of providing security is a function of the user's desired value and the parking location's actual feature of providing security. There could be multiple levels of security. In an embodiment, the score contributed by the parameter for desired maximum travel time from parking location to the final destination is a function of the user's desired value and the parking location's actual distance and time values. In an embodiment, the score contributed by the parameter of preferred method of travel between the parking location and the final destination is a function of the user's desired value and the actual known options.

In an embodiment, the score contributed by the parameter for limit of cost per unit of time is a function of the user's desired value, the vehicle type, the parking location's fee schedule values, the anticipated arrival time, anticipated leaving time, and the user's desired parking lot features. In an embodiment, the score contributed by the parameter for limit of absolute cost is a function of the user's desired value, the vehicle type, the parking location's fee schedule values, the anticipated arrival time, anticipated leaving time, and the user's desired parking lot features. In an embodiment, the scores are stored and accessed in parking space database 134.

In an embodiment, the filtered parking space options are presented in list format beginning with the highest matching score. In an embodiment, the list will be for parking options, meaning that there could be multiple options for one parking location at various places in the list. In an embodiment, a user selects a parking option to reserve a space at that desired parking option. In an embodiment, a user selects a parking option and receives navigation information to the parking option. In an embodiment, a user selects a parking option and receives information on the parking option, such as the address, price, amenities, availability, phone number, and website.

In an embodiment, a computer-implemented process for vehicle parking options ranking is disclosed. The computer-implemented method includes, in response to receiving a set of ranked user parking preferences and parking requirements, parsing the set of ranked user parking preferences and parking requirements. The computer-implemented method further includes, in response to receiving parking space data associated with a plurality of parking spaces, parsing the parking space data. The computer-implemented method further includes determining one or more optimal parking spaces based on comparing the set of ranked user parking preferences and parking requirements to the parking space data associated with the plurality of parking spaces. The computer-implemented method further includes generating a recommendation for an optimal parking space for the user. The computer-implemented method further includes presenting the recommendation for the optimal parking space to the user.

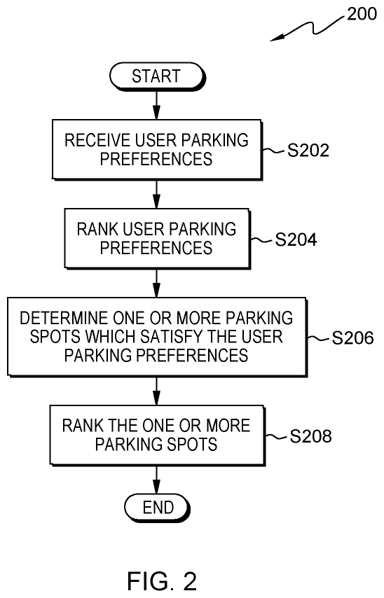

FIG. 2 is a flow chart diagram depicting operational steps for determining parking spaces based on user preferences, generally designated 200, in accordance with at least one embodiment of the present invention. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

At step S202, parking preference program 101 receives user parking input. In an embodiment, the user parking input includes at least one of user parking preferences and user parking requirements.

At step S204, parking preference program 101 ranks the user parking input. In an embodiment, parking preference program 101 ranks the user parking input based, at least in part, on the user input. In an embodiment, parking preference program 101 ranks the user parking input based, at least in part, on one or more parking preferences or parking requirements.

At step S206, parking preference program 101 determines one or more parking spaces which satisfy the user parking input. In an embodiment, parking preference program 101 compares the user parking input to parking lot accommodations and amenities to determine one or more parking spaces which satisfy the user parking input. For example, parking preference program 101 compares user parking input of “handicap accessibility” to parking spaces which include “handicap accessibility.” In an embodiment, parking preference program 101 determines one or more optimal parking spaces based, at least in part, on identifying one or more parking spaces that satisfy the highest number of ranked parking preferences and parking requirements of the user. In an embodiment, parking preference program 101 determines one or more optimal parking spaces based, at least in part, on identifying one or more parking spaces that satisfy a highest matching ranked parking preference and/or parking requirement.

At step S208, parking preference program 101 ranks the one or more parking spaces. In an embodiment, parking preference program 101 ranks the one or more parking spaces based, at least in part, on user input. In an embodiment, parking preference program 101 filters the one or more ranked parking spaces. In an embodiment, parking preference program 101 determines a final match score based on the filtered list of ranked parking spaces. In an embodiment, the final match score is determined, based, at least in part on, one or more of: (i) the scores of each preference parameter; (ii) the rankings of each preference parameter; (iii) additional considerations which include overridden user preferences for a particular day, time of day, or particular venue, (iv) variable factors such as current user location, route, route traffic conditions, and route meteorological data; (v) past choices a user has made during previous instances of parking, (vi) the desired arrival and leaving time; and (vii) an estimated number of available parking spaces at a particular parking location. In an embodiment, parking preference program 101 generates a parking space recommendation based on the filtered list of ranked parking spaces. In an embodiment, parking preference program 101 transmits the parking space recommendation to a user.

FIG. 3 is a block diagram depicting components of a computing device, generally designated 300, suitable for parking preference program 101 in accordance with at least one embodiment of the invention. Computing device 300 includes one or more processor(s) 304 (including one or more computer processors), communications fabric 302, memory 306 including, RAM 316 and cache 318, persistent storage 308, which further includes parking preference program 101, communications unit 312, I/O interface(s) 314, display 322, and external device(s) 320. It should be appreciated that FIG. 3 provides only an illustration of one embodiment and does not imply any limitations with regard to the environments in which different embodiments may be implemented. Many modifications to the depicted environment may be made.

As depicted, computing device 300 operates over communications fabric 302, which provides communications between computer processor(s) 304, memory 306, persistent storage 308, communications unit 312, and input/output (I/O) interface(s) 314. Communications fabric 302 can be implemented with any architecture suitable for passing data or control information between processor(s) 304 (e.g., microprocessors, communications processors, and network processors), memory 306, external device(s) 320, and any other hardware components within a system. For example, communications fabric 302 can be implemented with one or more buses.

Memory 306 and persistent storage 308 are computer readable storage media. In the depicted embodiment, memory 306 includes random-access memory (RAM) 316 and cache 318. In general, memory 306 can include any suitable volatile or non-volatile one or more computer readable storage media.

Program instructions for parking preference program 101 can be stored in persistent storage 308, or more generally, any computer readable storage media, for execution by one or more of the respective computer processor(s) 304 via one or more memories of memory 306. Persistent storage 308 can be a magnetic hard disk drive, a solid-state disk drive, a semiconductor storage device, read-only memory (ROM), electronically erasable programmable read-only memory (EEPROM), flash memory, or any other computer readable storage media that is capable of storing program instructions or digital information.

Media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 312, in these examples, provides for communications with other data processing systems or devices. In these examples, communications unit 312 can include one or more network interface cards. Communications unit 312 may provide communications through the use of either or both physical and wireless communications links. In the context of some embodiments of the present invention, the source of the various input data may be physically remote to computing device 300 such that the input data may be received, and the output similarly transmitted via communications unit 312.

I/O interface(s) 314 allows for input and output of data with other devices that may operate in conjunction with computing device 300. For example, I/O interface(s) 314 may provide a connection to external device(s) 320, which may be as a keyboard, keypad, a touch screen, or other suitable input devices. External device(s) 320 can also include portable computer readable storage media, for example thumb drives, portable optical or magnetic disks, and memory cards. Software and data used to practice embodiments of the present invention can be stored on such portable computer readable storage media and may be loaded onto persistent storage 308 via I/O interface(s) 314. I/O interface(s) 314 also can similarly connect to display 322. Display 322 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 4 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

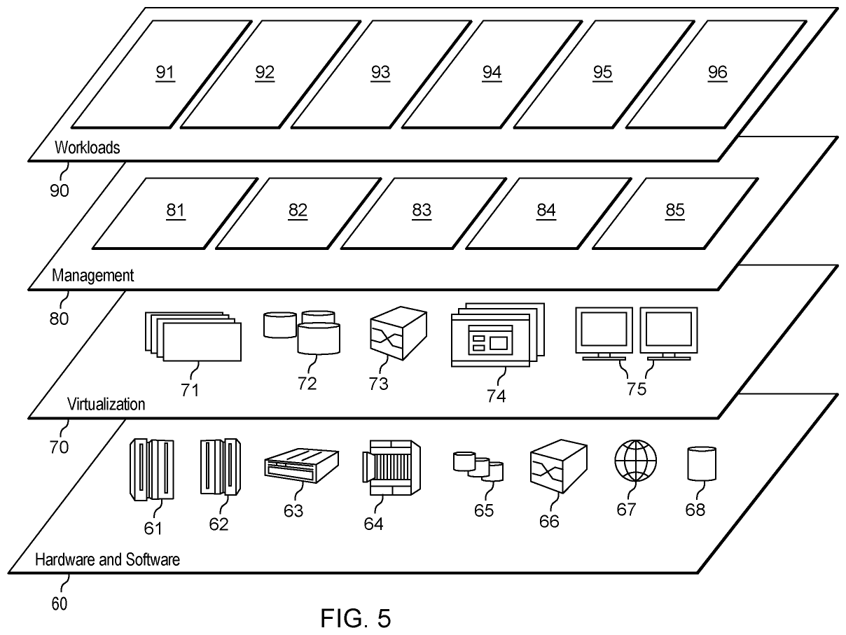

FIG. 5 is block diagram depicting a set of functional abstraction model layers provided by cloud computing environment 50 depicted in FIG. 4 in accordance with at least one embodiment of the present invention. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and vehicle parking analysis and identification 96.

What is claimed is:

1. A computer-implemented method for vehicle parking analysis and identification, the computer-implemented method comprising:
determining one or more parking preferences and one or more parking requirements of a user;
determining one or more parking spaces based on comparing one or more ranked parking preferences and one or more ranked parking requirements of the user to parking data associated with one or more available parking spaces; and
generating a parking space recommendation, wherein the parking space recommendation includes one or more optimal parking spaces selected from the one or more available parking spaces.

2. The computer-implemented method of claim 1, further comprising:
ranking the one or more parking preferences and the one or more parking requirements of the user.

3. The computer-implemented method of claim 1, further comprising ranking the one or more parking spaces based, at least in part, on: (i) an amount of allotted time of the user to travel from a parking space to a final destination; (ii) a preferred travel method from the parking space to the final destination; (iii) a limit of cost per unit of time; (iv) an absolute cost; and (v) one or more preferred parking space amenities.

4. The computer-implemented method of claim 2, wherein ranking the one or more parking spaces is further based, at least in part, on the one or more ranked parking preferences and the one or more ranked parking requirements of the user.

5. The computer-implemented method of claim 2, wherein ranking the one or more parking spaces further includes:
determining a parking space match score, wherein the parking space match score is a total of a plurality of specified parking parameters, each of the plurality of specified parking parameters being calculated as functions of the difference between the user's parking preference value or the user's parking requirement values and a parking spaces actual values.

6. The computer-implemented method of claim 4, wherein the plurality of specified parking parameters include: (i) overridden user preferences for a particular parking event; (ii) current user location; (iii) current user route; (iv) current route traffic conditions; (v) historical parking information; and (vi) available parking space supply at a particular parking location.

7. The computer-implemented method of claim 1, wherein the parking space recommendation is further generated based, at least in part, on historical parking information associated with the user.

8. A computer program product for determining parking spots based on user preferences, the computer program product comprising one or more computer readable storage media and program instructions stored on the one or more computer readable storage media, the program instructions including instructions to:
determine one or more parking preferences and one or more parking requirements of a user;
determine one or more parking spaces based on comparing one or more ranked parking preferences and one or more ranked parking requirements of the user to parking data associated with one or more available parking spaces; and
generate a parking space recommendation, wherein the parking space recommendation includes the one or more optimal parking spaces selected from the one or more available parking spaces.

9. The computer program product of claim 8, further comprising instructions to:
rank the one or more parking preferences and the one or more parking requirements of the user.

10. The computer program product of claim 8, further comprising ranking the one or more parking spaces based, at least in part, on: (i) an amount of allotted time of the user to travel from a parking space to a final destination; (ii) a preferred travel method from the parking space to the final destination; (iii) a limit of cost per unit of time; (iv) an absolute cost; and (v) one or more preferred parking space amenities.

11. The computer program product of claim 9, wherein ranking the one or more parking spaces is further based, at least in part, on the one or more ranked parking preferences and the one or more ranked parking requirements of the user.

12. The computer program product of claim 9, wherein ranking the one or more parking spaces further includes:
determining a parking space match score, wherein the parking space match score is a total of a plurality of specified parking parameters, each of the plurality of specified parking parameters being calculated as functions of the difference between the user's parking preference value or the user's parking requirement values and a parking spaces actual values.

13. The computer program product of claim 11, wherein the plurality of specified parking parameters include: (i) overridden user preferences for a particular parking event; (ii) current user location; (iii) current user route; (iv) current route traffic conditions; (v) historical parking information; and (vi) available parking space supply at a particular parking location.

14. The computer program product of claim 8, wherein the parking space recommendation is further generated based, at least in part, on historical parking information associated with the user.

15. A computer system determining parking spots based on user preferences, comprising:
one or more computer processors;
one or more computer readable storage media; and
computer program instructions, the computer program instructions being stored on the one or more computer readable storage media for execution by the one or more computer processors, the computer program instructions including instructions to:
determine one or more parking preferences and one or more parking requirements of a user;
determine one or more optimal parking spaces based on comparing one or more ranked parking preferences and one or more ranked parking requirements of the user to parking data associated with one or more available parking spaces; and
generate a parking space recommendation, wherein the parking space recommendation includes the one or more parking spaces selected from the one or more available parking spaces.

16. The computer system of claim 15, further comprising instructions to:
rank the one or more parking preferences and the one or more parking requirements of the user.

17. The computer system of claim 15, further comprising ranking the one or more parking spaces based, at least in part, on: (i) an amount of allotted time of the user to travel from a parking space to a final destination; (ii) a preferred travel method from the parking space to the final destination; (iii) a limit of cost per unit of time; (iv) an absolute cost; and (v) one or more preferred parking space amenities.

18. The computer system of claim 16, wherein ranking the one or more parking spaces is further based, at least in part, on the one or more ranked parking preferences and the one or more ranked parking requirements of the user.

19. The computer system of claim 16, wherein ranking the one or more parking spaces further includes:
determining a parking space match score, wherein the parking space match score is a total of a plurality of specified parking parameters, each of the plurality of specified parking parameters being calculated as functions of the difference between the user's parking preference value or the user's parking requirement values and a parking spaces actual values.

20. The computer system of claim 18, wherein the plurality of specified parking parameters include: (i) overridden user preferences for a particular parking event; (ii) current user location; (iii) current user route; (iv) current route traffic conditions; (v) historical parking information; and (vi) available parking space supply at a particular parking location.
